(19) United States
(12) Patent Application Publication
(10) Pub. No.: US 2010/0092115 A1
(43) Pub. Date: Apr. 15, 2010

(54) HYDRODYNAMIC BEARING WITH ASYMMETRICAL LOBES

(75) Inventor: Michel Wendling, Strasbourg (FR)

Correspondence Address: OLIFF & BERRIDGE, PLC, P.O. BOX 320850, ALEXANDRIA, VA, 22320-4850, US

(73) Assignee: FLENDER GRAFFENSTADEN S.A.S., Illkirch (FR)

(21) Appl. No.: 12/451,532

(22) PCT Filed: May 23, 2008
(86) PCT No.: PCT/FR2008/050897

§ 371 Date: Dec. 2, 2009

(30) Foreign Application Priority Data
May 24, 2007 (FR) 0703691

(51) Int. Cl. F16C 27/00

(52) U.S. Cl. 384/99

(57) ABSTRACT

Hydrodynamic bearing with four lobes with centres of curvature that are eccentric relative to its geometrical centre, said lobes being separated by oil feed grooves wherein the lobes are dissymmetrical and present;—angular apertures of at least two different values;—at least two different eccentricities relative to the geometrical centre of the bearing; the centres of two opposing lobes being aligned with the geometrical centre of the bearing.

The present invention relates to a hydrodynamic bearing with four lobes intended to operate under high loads and high speeds while having a stable operation under no load. Its specific capabilities are particularly sought in the case of bearings of high power speed-increasing or speed-reducing gear shafts.

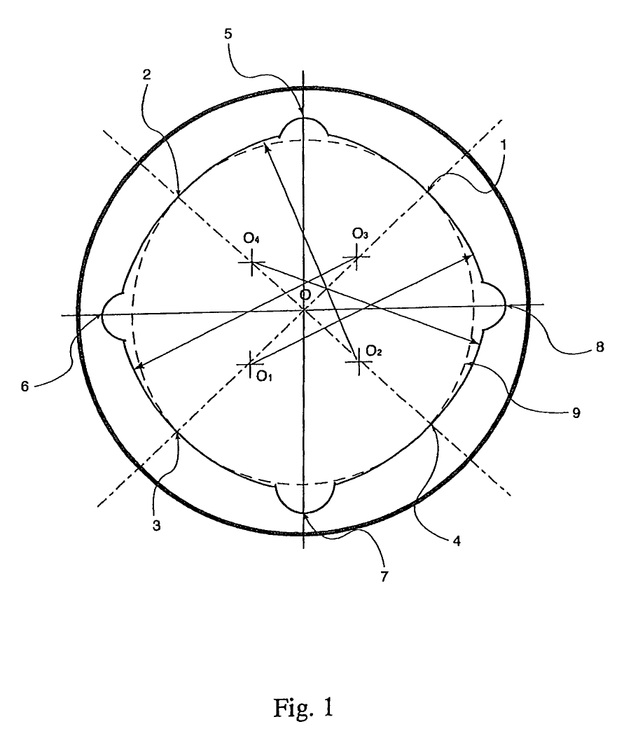

The use of hydrodynamic bearings with four symmetrical lobes is well known and very widespread. Said lobes are four identical cylindrical sliding surfaces obtained by boring with diameters slightly greater than the assembly diameter of the bearing, as this is illustrated in FIG. 1.

The angular apertures of the lobes are identical and four oil feed grooves are machined between the lobes. With such a configuration, in which the centers of the bores of the loads are excentered relatively to the geometrical center of the bearing, it is possible to obtain four pre-loading effects on the shaft. These effects are particularly interesting for improving hydrodynamic stability of the film bearing the shaft in the cases of operation under a low radial load and at high speed, or in the cases of operating lines of rapid shafts with critical dynamic behaviors.

The symmetrical arrangement of the loads further allows the shaft to rotate in both directions of rotation with identical bearing capacity. Under the assumption of selecting large values of excentration of the lobes for producing high pre-loads, it is also possible to guarantee that, whichever the angular direction of the load, the shaft will never be positioned on an oil distribution groove, which would have the effect of causing a drop in the bearing capacity of the shaft or hydrodynamic vibratory instabilities.

The use of a bearing with four symmetrical lobes is therefore particularly well adapted to the case of operations at high sliding speeds and for variable radial loads of low or moderate level, or also variable angular orientation.

In this configuration, taking into account the space required for distributing oil to the friction surfaces, the angular aperture of each of the feeding grooves is of the order of 20°, which limits the angular aperture of each of the bearing surfaces to about 70°. This value explains the low load capacity of a standard bearing with four lobes as compared for example with that of a bearing with two fixed lobes, the active apertures of which are larger than 150°.

The object of the present invention by modifying the angular aperture of each of the four lobes allows high loading capacities to be obtained, while keeping the aforementioned advantages of the bearing with four symmetrical lobes. For this purpose, the hydrodynamic bearing of the invention, also provided with four lobes with excentered curvature centers relatively to its geometrical center, said lobes being conventionally separated by oil feed grooves, is mainly characterized in that the lobes are dissymmetrical and have:
angular apertures of at least two different values;
at least two different eccentricities relatively to the geometrical center of the bearing;
   the centers of two opposite lobes being aligned with the geometrical center of the bearing.

In this new configuration, the four lobes do not fulfill the same functions, whence their different geometry. It is thus possible to assign to one of the lobes a significantly larger angular aperture than that of the other ones, so as to obtain a maximum bearing surface area. In this case, this lobe is the loading lobe. With the high value of its angular aperture it is possible, for an identical applied force, to obtain lower pressure peak values in the oil corner and larger oil film thicknesses. These better bearing performances have the consequence of an improvement in the endurance strength of the anti-friction metal of the sliding surface and a reduction in the temperature at the location where the thickness of the film is minimum. The excentration relatively to the geometrical center of the bearing, of the center of the maximum angular aperture lobe as well as the value of the loading angle are selected so as to have optimum bearing conditions of the oil film.

The three other lobes of more reduced angular aperture, are holding and stabilizing lobes. For this reason, the excentrations of their center have much larger values than the excentration of the center of the loading lobe. The selection of the excentrations and of the angular apertures of the active surfaces of the four lobes ensures continuity in guiding the shaft. As in the case of a bearing with four symmetrical lobes, the shaft may not come into contact with the lubrication and cooling devices positioned between the end of the active sliding surface of a lobe and the beginning of the active area of the following lobe.

The lobes may moreover have at least two different axial widths.

According to the invention, for a shaft centered on the geometrical center of the bearing, the points with minimum play of two opposite lobes are aligned with the geometrical center of the bearing.

Under this assumption, these points are located on a circle, the diameter of which corresponds to the assembly diameter of the bearing. With this arrangement it is possible to retain for the bearing with four dissymmetrical lobes the facility of dimensionally controlling the assembly diameter which bearings with four symmetrical lobes have.

The bearing of the invention may consist of two half-shells each with an angular aperture of 180°.

More specifically, each of these half-shells may include two lobes and two grooves. The gasket plane of the bearing is angularly oriented so that the rated load is directed on the loading lobe.

The invention will now be described in more detail with reference to the different figures, for which:

FIG. 1 is a sectional view of a bearing with four symmetrical lobes forming the prior art;

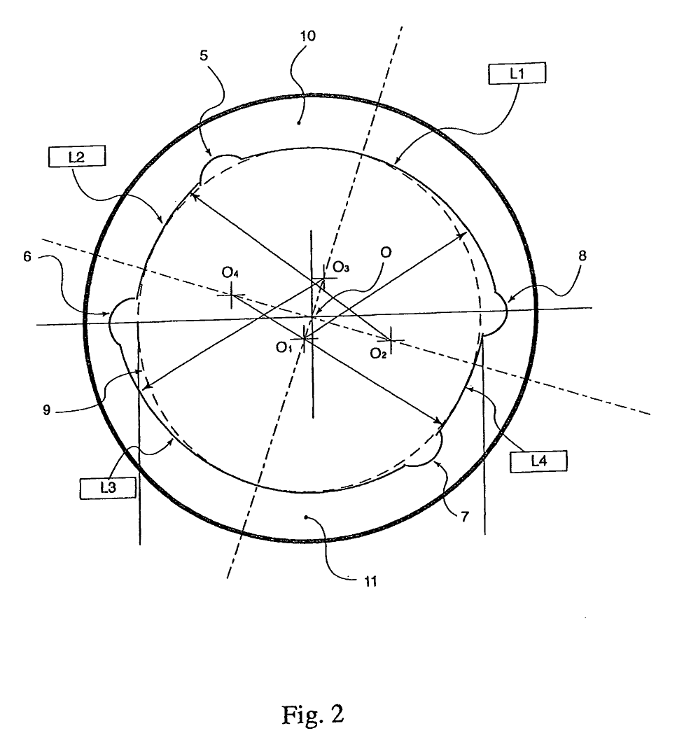

FIG. 2 illustrates a bearing with four dissymmetrical lobes, object of the present invention.

With reference to FIG. 1, the four lobes (1, 2, 3, 4) are symmetrical, i.e.

they have the same angular aperture and the same radius of curvature. Thus, the four centers (O1, O2, O3, O4) of the arcs which make them up are positioned symmetrically relatively to the geometrical center (O) of the bearing, which is in practice located at the intersection of the diagonals of this square formed by said points (O1-O4). The lobes (1, 2, 3, 4) are separated by grooves (5, 6, 7, 8) provided for feeding oil.

The circle (9) illustrated in FIG. 1 in dotted lines passes through four points which appear at the location to which the arrows point, schematizing the four lobes (1, 2, 3, 4) at the intersection between said lobes (1, 2, 3, 4) and the lines (O1, O3) and (O2, O4) respectively. The diameter of this circle corresponds to the assembly diameter of the bearing.

As already mentioned, such a bearing is adapted to assumptions of operation at high sliding speed and variable radial loads of low to moderate level.

One of the advantages of this configuration may be seen in the fact that this bearing operates in the same way in both possible directions of rotation. It however has limitations in the case of operation under a high load and at high speed.

The bearing appearing in FIG. 2, which is the object of the present invention, finds a remedy to these drawbacks and proposes a configuration which is perfectly adapted to high loads, even under the assumptions of high speed.

This bearing is dissymmetrical, i.e. the angular sectors covered by each of the lobes (L1, L2, L3, L4) are different.

As a corollary, the eccentricities of the centers (O1, O2, O3, O4) relatively to the geometrical center (O) of the bearing are also variable from one lobe to the other. The lobe (L1) is the loading lobe. Its angular aperture is consequently much higher than that of the lobe (L2), so as to obtain a maximum bearing surface. The bearing in the case in point consists of two half-shells (10, 11). The lobes (L1) and (L2) are located in the half bearing (10), while the lobes (L3) and (L4) are positioned in the other half bearing (11).

The gasket plane is oriented angularly so that the rated load is directed on the lobe (L1). The angular sector of the lobe (L1), as well as the radius of curvature and consequently the excentration of (O1) relatively to (O) allows optimum bearing of the oil film notably resulting from a reduction in the pressure peak values in the oil corner, as well as from an increase in the thicknesses of the oil film at the lobe (L1). The anti-friction metal of the sliding surface has better mechanical endurance strength because of these increased bearing performances.

The lobes (L2)-(L4) are stabilization and holding lobes having larger excentrations of the points (O2)-(O4) than that of the lobe (L1).

The selection of these excentrations as well as the selection of the angular apertures of the active surfaces of the four lobes ensures continuity of the guiding of the shaft. The latter in this configuration, cannot come into contact with the lubrication and cooling devices placed between two successive lobes. It should be noted that in this configuration, even the oil feed grooves (5)-(8) may be angularly dissymmetrical, and in axial width.

This solution, in addition to the clear improvement in the bearing capacity of the oil film at the loading lobe, allows dimensioning of the sliding surfaces of the unloaded lobes so as to optimize cooling of the bearing and reduce losses by friction.

1. A hydrodynamic bearing with four lobes with centers of curvature excentered relatively to its geometrical center, said lobes being separated by oil feed grooves,
wherein the lobes are dissymmetrical and have:
angular apertures of at least two different values;
at least two different eccentricities relatively to the geometrical center of the bearing;
the centers of two opposite lobes being aligned with the geometrical center of the bearing.

2. The hydrodynamic bearing with four lobes according to claim 1, wherein the lobes have at least two different axial widths.

3. The hydrodynamic bearing with four lobes according to claim 2, wherein, for a shaft centered at the geometrical center of the bearing, the points with minimum play of two opposite lobes are aligned with the geometrical center of the bearing.

4. The hydrodynamic bearing with four lobes according to claim 1, wherein the points with minimum play of the four lobes, when the shaft is centered at the geometrical center of the bearing, are located on a circle, the diameter of which corresponds to the assembly diameter of the bearing.

5. The hydrodynamic bearing with four lobes according to claim 1, wherein it consists of two half-shells with an angular aperture of 180°.

6. The hydrodynamic bearing with four lobes according to claim 5, wherein it includes two lobes and two grooves per half-shell.

7. The hydrodynamic bearing with four lobes according to claim 2, wherein the points with minimum play of the four lobes, when the shaft is centered at the geometrical center of the bearing, are located on a circle, the diameter of which corresponds to the assembly diameter of the bearing.

8. The hydrodynamic bearing with four lobes according to claim 3, wherein the points with minimum play of the four lobes, when the shaft is centered at the geometrical center of the bearing, are located on a circle, the diameter of which corresponds to the assembly diameter of the bearing.

9. The hydrodynamic bearing with four lobes according to claim 2, wherein it consists of two half-shells with an angular aperture of 180°.

10. The hydrodynamic bearing with four lobes according to claim 3, wherein it consists of two half-shells with an angular aperture of 180°.

11. The hydrodynamic bearing with four lobes according to claim 4, wherein it consists of two half-shells with an angular aperture of 180°.

12. The hydrodynamic bearing with four lobes according to claim 7, wherein it consists of two half-shells with an angular aperture of 180°.

13. The hydrodynamic bearing with four lobes according to claim 8, wherein it consists of two half-shells with an angular aperture of 180°.

14. The hydrodynamic bearing with four lobes according to claim 9, wherein it includes two lobes and two grooves per half-shell.

15. The hydrodynamic bearing with four lobes according to claim 10, wherein it includes two lobes and two grooves per half-shell.

16. The hydrodynamic bearing with four lobes according to claim 11, wherein it includes two lobes and two grooves per half-shell.

17. The hydrodynamic bearing with four lobes according to claim 12, wherein it includes two lobes and two grooves per half-shell.

18. The hydrodynamic bearing with four lobes according to claim 13, wherein it includes two lobes and two grooves per half-shell.
